(19) United States
(12) Patent Application Publication
(10) Pub. No.: US 2025/0001385 A1
(43) Pub. Date: Jan. 2, 2025

(54) Plasma Device With Inductively Coupled Electromagnets

(71) Applicant: Rimere, LLC, Lafayette, CO (US)

(72) Inventor: Garrett Hill, Boulder, CO (US)

(21) Appl. No.: 18/760,839

(22) Filed: Jul. 1, 2024

Related U.S. Application Data
(60) Provisional application No. 63/524,190, filed on Jun. 29, 2023.

(51) Int. Cl. B01J 19/08; B01J 19/12

(52) U.S. Cl. CPC B01J 19/088; B01J 19/126; B01J 2219/0875; B01J 2219/0877; B01J 2219/1269

(57) ABSTRACT

Systems, methods, and devices using plasma to reform a hydrocarbon feedstock are described. A hydrocarbon feedstock is introduced to a first reaction zone having a first plasma, where the first plasma increases the excitation of the hydrocarbon, which could be up to 100% of the dissociation level. The excited hydrocarbons are then introduced to a glide arc plasma, which raises the excitation levels of the hydrocarbons past the dissociation level. Microwave energy is introduced to the glide arc plasma to propagate the hybrid plasma and maintain dissociation of the hydrocarbons, allowing for filtration of particulate and capture of hydrogen and carbon. Inductive coupling to the hybrid plasma may be further used to monitor reaction conditions in the hybrid plasma and maintain desired excitation of the hydrocarbons.

This application claims priority to U.S. provisional application No. 63/524,190, filed Jun. 29, 2023, the disclosure of which is incorporated herein by reference.

### FIELD OF THE INVENTION

The field of the invention is plasma systems.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Using plasmas to process or reform various fluids, gases, or contents thereof can be useful in energy production. For example, plasmas can be applied to hydrocarbon feedstocks to form lighter hydrocarbons, carbon, or hydrogen. Such systems can use one or more plasmas, or multiple types of plasmas. While such production is desirable, high energy plasma systems can be hazardous, vulnerable to system damage, or difficult to operate or maintain in long term or continuous applications. It appears commercially practical plasma reforming systems are needed to improve energy production and refining.

Thus, there remains a need for systems, devices, and methods to improve the durability or performance of plasma devices for reforming energy rich fluids or gases, thereby extending the operability of such processes.

### SUMMARY

The inventive subject matter provides apparatus, systems, and methods in which plasmas reform feedstock, for example hydrocarbons such as natural gas, to release hydrogen and carbon. A tube includes an inlet to receive a feedstock, and an outlet to discharge reformation products of the feedstock, generally hydrogen gas and carbon. A first reaction or energy zone within the tube includes a first plasma, preferably a dielectric barrier discharge plasma. The first plasma is selected and tuned to increase the excitation level of a hydrocarbon in the feedstock to less than its dissociation level, for example to between 1%-99% of the dissociation level. A second reaction or energy zone is arranged at least partially downstream of the first reaction zone. The second reaction zone includes a first and a second electrode that deliver an electric discharge, in some embodiments into the first plasma, thereby producing a second plasma. A third reaction or energy zone is arranged at least partially downstream of the first reaction zone, preferably downstream of the second reaction zone. The third reaction zone directs a first energy (e.g., microwave or other electromagnetic energy), in some embodiments into the first plasma but preferably into the second plasma, to produce a third plasma.

It should be appreciated that each of the first, second, or third plasmas can propagate or extend from, to, and between adjacent and subsequent reaction zones, generally in a downstream direction (e.g., from first reaction zone, toward second adjacent reaction zone, to third reaction zone adjacent the second reaction zone.). As feedstock moves through the different reaction zones, each plasma resident in the reaction zones energizes or excites the molecules of the feedstock to various degrees. Molecules of the feedstock are excited at or beyond a dissociation energy of the molecule, rendering the molecules into their constituent components, for example hydrogen and carbon in various forms and combinations.

In some embodiments the first plasma is a DBD plasma, a corona plasma, a pulsed plasma, a nano-pulsed plasma, or an electron-beam induced plasma. Generally such plasmas have a frequency between 50 Hz and 40 KHz. The first plasma preferably initiates excitation in the molecules of the feedstock partially up-to the dissociation energy of the molecules, for example vibrational excitation levels. The first plasma can also otherwise energize electrons of the molecules in the feedstock, or energize molecules of the feedstock between 50% and 95% of a dissociation energy of the molecule.

A voltage is generally applied across the first and second electrodes, for example between 1 KV and 60 KV. The first electrode is generally positioned within a lumen of the tube, and the second electrode forms at least a portion of a wall of the tube. In some embodiments the second plasma is a glide-arc plasma (e.g., rotating glide-arc) having a frequency between 50 Hz and 40 KHz. The third plasma can be a microwave plasma with a frequency between 300 MHz and 4 GHZ.

Thus embodiments include reforming systems having a DBD plasma (e.g., one or more electrodes for generating DBD plasma) arranged sequentially with a glide-arc plasma (e.g., one or more electrodes for generating a glide-arc plasma) and a microwave plasma (e.g., one or more waveguides or electromagnetic generators or microwave emitters to generator or direct microwaves), preferably in that order. The plasmas can interact or overlap with each other providing a continuous series of plasma throughout the reformer, with the plasmas or plasma having gradients or transitions of energy and flow characteristics across, between, or extending from each reaction or energy zone.

The order of the plasmas can be changed to provide new functionality or improved features of the reformer, for example to provide improved carbon filtration between reaction zones or to improve conversion rates of the feedstock to the target output. The first reaction zone can include one or more DBD plasmas while the second reaction zone includes a microwave plasma and the third reaction zone includes a glide-arc plasma. In such embodiments a carbon filter is included between the reaction zones, for example between a microwave plasma zone and a subsequent glide-arc plasma zone. Likewise a fourth reaction zone can be arranged partially downstream of the first, second, or preferably the third reaction zone to direct a second microwave energy into the third plasma, producing a fourth plasma. Such multiple, serial, or parallel microwave energies can be generated by shared or separate microwave generators, as well as directed, tuned, or filtered by shared or separate waveguides or wavefilters.

It can be favorable to calibrate or otherwise tune characteristics of each plasma to achieve complementary dissociation of the feedstock molecules in various portions of the reformer. The first, second, or third plasmas (or fourth) can be tuned to a frequency that is a harmonic of another plasma frequency, whether or not immediately preceding. For example the third plasma frequency can be tuned to one of the first or the second plasma frequency. Likewise, heats, velocities, densities, mixing dynamics, or energy of the various plasmas can be tuned for complementary, synergistic, or coordinated effect. As noted previously, such effects include increasing or otherwise controlling the dissociation of feedstock molecules at different locations of the reformer to improve filtering of dissociated particles or non-hydrogen byproducts and prevent undesired accumulation of carbon, sulfur, or metals, for example.

Viewed from another perspective, a key interest of the inventive subject matter is coordinating plasma reaction zones to prime the excitation levels of the hydrocarbons in the feedstock to levels below dissociation until the primed hydrocarbons reach portions of the system suited for maintaining prolonged hydrocarbon dissociation or capture of hydrogen or carbon.

In some embodiments the energy directed toward one or more of the plasmas is a microwave energy. A microwave emitter can be used to direct the microwave energy into one of the reaction zones, for example the third reaction zone (or third in order reaction zone), via a waveguide. One or more waveguides typically extend along at least 2.5, 5, 10, 20, 50, 100, 200, 400, or more cm of a length of the tube (individually or in combination) and can extend between one or more reaction zones, continuously or intermittently.

In some embodiments it is favorable to have no active electrodes in direct contact with one or more of the plasmas or exposed to one or more of the reaction zones. For example one or more inductively coupled plasmas can be produced in a reaction zone of the reformer to direct energy from operation of inductive coils (e.g., primarily a low-turn coil) disposed about a reaction zone. Additional low turn coils, high-turn coils, or pairs or groupings of low turn and high turn coils can be integrated, applied, or added to one or more of the reaction zones to energize electrodes or couple with a resident plasma for EM feedback, energy input, or control. Such inductively coupled plasma zones prevent exposure of an electrode to a plasma or the feedstock, thereby reducing degradation of the electrode or potential build up of carbon or other dissociated particles from the feedstock onto the electrode.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A depicts a system embodiment of the inventive subject matter.

FIG. 1B depicts another system embodiment of the inventive subject.

FIG. 2 depicts a schematic diagram of a system embodiment of the inventive subject matter.

FIG. 3 depicts a schematic diagram of another system embodiment of the inventive subject matter.

FIG. 4 depicts a schematic diagram of a further system embodiment of the inventive subject matter.

FIG. 5 depicts another system embodiment of the inventive subject matter.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

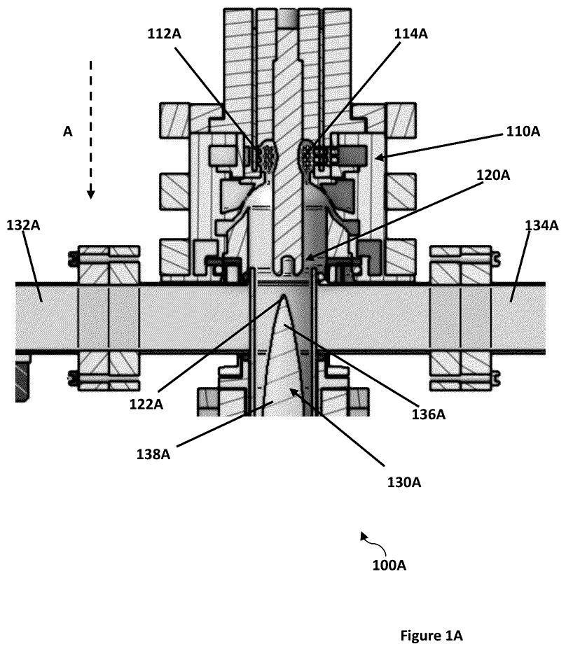

FIG. 1A depicts a portion of a system 100A of the inventive subject matter for reforming a hydrocarbon feedstock into hydrogen, carbon, and lighter hydrocarbons (compared to those in the feedstock). The system 100A comprises a tube having an inlet configured to receive the feedstock, and an outlet configured to discharge reformation products formed by reforming the feedstock through a plurality of reaction zones within the tube. An inlet 110A receives a hydrocarbon feedstock, for example natural gas or other lighter hydrocarbons (e.g., hydrocarbons having less than 6, 5, 4, 3, or 2 carbon atoms), preferably at a temperature less than 1200° C. The hydrocarbon feedstock is first energized by a first reaction zone configured to generate a first plasma using electrodes 112A and 114A. The electrodes 112A and 114A may be separated by an insulating barrier and configured to generate a DBD plasma. The electrodes 112A and 114A are part of an array of electrodes that create a DBD plasma, preferably with a plasma temperature less than 500° C. In some embodiments electrodes 112A and 114A are energized directly by a (preferably high) voltage power source, through the electrodes may be energized by inductive coupling.

The DBD plasma acts upon the hydrocarbon feedstock to excite the hydrocarbons from a ground state level to a level below the dissociation level of the hydrocarbon, for example 90% of dissociation level, vibrational excitation, etc. This creates a hydrocarbon feedstock in an excited state but that has not formed, precipitated, or accumulated carbon from the feedstock. A noted feature of the inventive subject matter is to excite the hydrocarbon energy state via DBD plasma at or around the electrodes 112A and 114A without substantially initiating dissociation of the hydrocarbons and accumulation of carbon in the system. As such, in some embodiments plasmas other than DBD plasma may be formed by the electrodes 112A and 114A to excite the hydrocarbons up to the dissociation point, including corona plasma, a pulsed plasma, a nano-pulsed plasma, or an electron-beam induced plasma, alone or in combination. As described herein, substantial dissociation of a molecule may not occur when the energy imparted to the molecule does not exceed 50% and 95% of a dissociation energy of the molecule.

The excited hydrocarbon feedstock flows through the system 100 in the direction of arrow A toward a second reaction zone at least partially downstream of the first reaction zone. The second reaction zone is configured to generate a second plasma using an electrode configuration 120A. The electrode configuration 120A may include first and second electrodes separated by a variable inter-electrode gap in a lengthwise direction of the tube and configured to deliver an electric discharge to produce a second plasma, e.g., a glide-arc plasma, which is different from the first plasma, e.g., a DBD plasma. The electrode configuration 120A forms a glide arc plasma in the path of flow of excited hydrocarbon feedstock, further exciting the hydrocarbons approaching and past the dissociation level of the hydrocarbons, or at least some, most, or nearly all of the hydrocarbons in the feedstock. As the hydrocarbons dissociate, hydrogen, carbon, and lighter hydrocarbons are formed in the flow path of the system 100A, termed a reforming feedstock. The reforming feedstock also flows through the system 100A in the direction of arrow A.

The electrode configuration 120A further energizes a plasma at point 122A. The plasma at point 122A is further energized by microwaves directed toward a point 136A by microwave emitters 132A and 134A (e.g., microwave channel, waveguide, etc.) in a lateral direction crossing the lengthwise direction of the tube. Further energizing the plasma at the point 122A to the point 136A continues the reaction reforming the hydrocarbon feedstock to hydrogen, carbon, and lighter hydrocarbons, as well as lighter hydrocarbons to hydrogen and carbon and still lighter hydrocarbons. The plasma 130A from the point 136A is propagated in the direction of arrow A, allowing the plasma 130A to continue to reform the hydrocarbon feedstock and intermittent lighter hydrocarbons to hydrogen along, between, and extending from the lengths of the plasma reaction zone, at least between the points 122A and 138A.

It is contemplated that further microwave emitters be disposed downstream of point 138A to further energize and maintain the plasma, generate further plasmas, or otherwise impart energy into the feedstock, reaction zones, or plasmas to extend or create further plasma reaction zones and increase the reformation of hydrocarbons and intermittent lighter hydrocarbons to hydrogen and carbon. Likewise, in some embodiments induction coils are disposed downstream of point 138A to further energize the plasma, extend the plasma reaction reforming the hydrocarbon feedstock and intermittent lighter hydrocarbons to hydrogen and carbon, and otherwise monitor plasma dynamics of the system via inductively coupled feedback.

FIG. 1B depicts a portion of system 100B of the inventive subject matter. The portion of FIG. 1B marked by dashed circle 100A is substantially as described above with respect to FIG. 1A. Plasma 140B extends from region 100A along a reaction zone in the direction of arrow B. Microwave emitters 132B and 134B (e.g., microwave channels, waveguides, generators, etc.) are directed toward plasma 140B between points 142B and 144B. Microwave energy from emitters 132B and 134B further energizes plasma 140B to continue reformation of feedstock hydrocarbon and intermittent lighter hydrocarbons to hydrogen and carbon. In some embodiments emitters 132B and 134B are controlled, generated, or directed separately, for example such that one emitter (e.g. 132B) primarily provides energy to maintain or drive reformation activity of plasma 140B while another emitter (e.g., 134B) is used to provide dynamic, finessed, or fine-tuned microwaves to augment, improve, or extend reformation activity of plasma 140B.

Plasma 140B extends in the direction of arrow B from point 144B, extending reformation activity of feedstock and intermittent lighter hydrocarbons to hydrogen and carbon. Further microwave emitters, electrode assemblies, inductive coils, or high-low turn coil pairings can be arranged or combined downstream of point 144B to continue reformation of feedstock hydrocarbons to lighter hydrocarbons, hydrogen, or carbon. In some embodiments, system 100B can achieve up to 70%, 80%, 90%, 99%, or 100% recovery of hydrogen from the hydrocarbon feedstock.

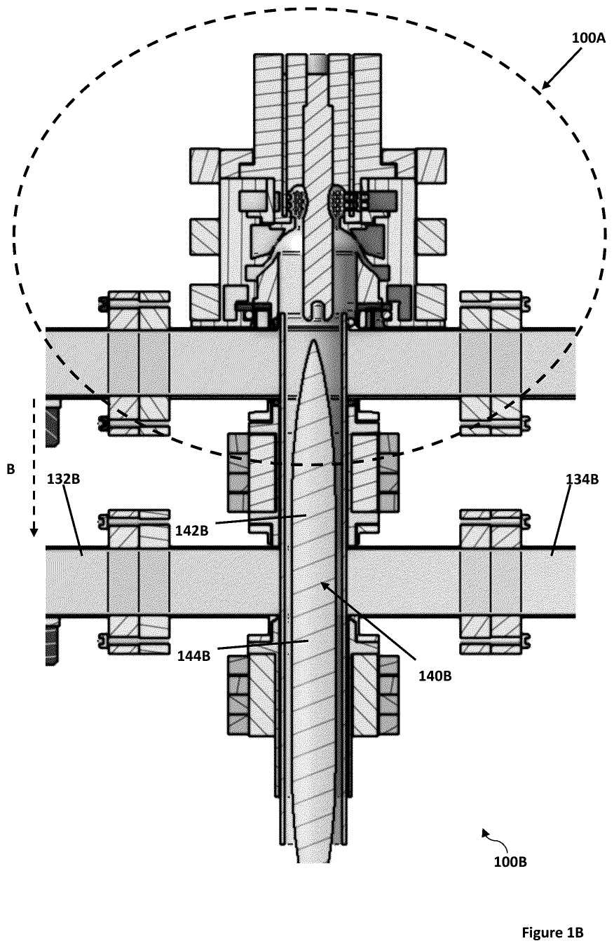

FIG. 2 depicts a diagram of system 200 of the inventive subject matter. A feedstock inlet supplies a hydrocarbon feedstock 210 (e.g., natural gas) to a pre-treatment zone 220. The pre-treatment zone 220 includes one (or more, an array, etc.) electrode to generate a plasma 222 in a pre-treatment zone 220. The plasma 222 is preferably a DBD plasma tuned to maintain a plasma temperature of less than 800° C., 700° C., 600° C., 500° C., 400° C., 300° C., 200° C., or less than 100° C. in the pre-treatment zone 220, and also to increase the excitation levels of the hydrocarbons in the feedstock. Specifically, the plasma 222 increases the excitation level of the hydrocarbons above the ground state but below the dissociation level for the hydrocarbons, for example within 90% of the dissociation energy for natural gas or other light hydrocarbons. Furthermore, temperature and pressure conditions of pre-treatment zone 220 are maintained at a level to avoid or prevent combustion of the feedstock or hydrocarbons therein. Other plasmas such as a corona plasma, a pulsed plasma, a nano-pulsed plasma, or an electron-beam induced plasma can be used, alternatively or in combination, to increase the excitation level of the hydrocarbons to approach but not exceed the hydrocarbon dissociation level.

Excitation of the hydrocarbon feedstock by the plasma 222 forms an excited feedstock 224. The excited feedstock 224 flows to an ignition zone 230, which is configured to generate a glide-arc plasma 232. The glide-arc plasma 232 is used to energize hydrocarbons in the excited feedstock 224 to an energy level higher than the dissociation level for hydrocarbons in the feedstock and initiate reforming of the hydrocarbons into their components of hydrogen, carbon, and lighter hydrocarbons (i.e., lighter hydrocarbon than found in the feedstock, intermittent hydrocarbons, etc.).

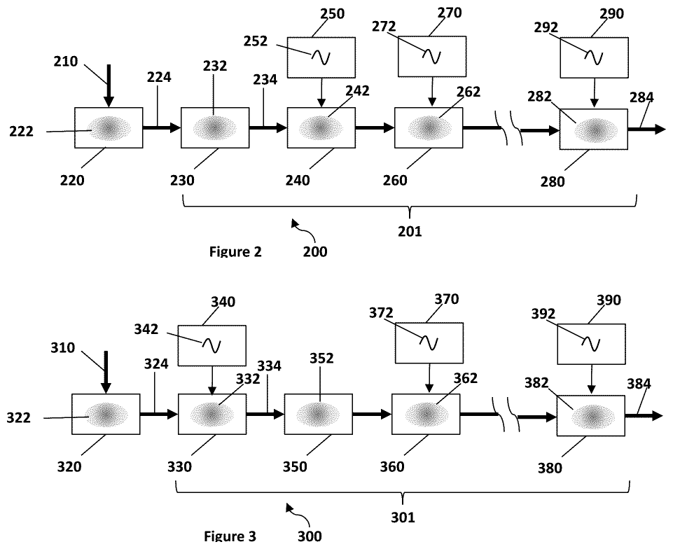

As describe herein, the feedstock 210 or 310 (of FIG. 3) that has partly been reformed into the components may be referred to herein as a reforming feedstock 234 or 334 (of FIG. 3), respectively. It should be appreciated that exciting the hydrocarbons to a sub-dissociation level (e.g., 90% of dissociation energy) reduces the amount of additional energy needed for dissociation of the hydrocarbons in subsequent reaction zones, which in turn increases the relative amount of hydrocarbons that are dissociated by glide-arc plasma 232 and the remaining reforming system.

Further, energizing the hydrocarbons of the feedstock to the level of reforming feedstocks 234 or 334 allows the system to confine or contain deposition of carbon from the feedstock to a predictable and controlled space, for example in reaction zone 240 or another reaction zone. Viewed from another perspective, preconditioning feedstock results in faster, and more complete, dissociation of hydrogen, lighter hydrocarbons, and carbon from the feedstock in zone 240, in some cases causing a bulk (e.g., 20%, 50%, 70%, 85%, or more) dissociation of carbon from the feedstock. In such cases, filtration or separation devices or methods can be used to separate carbon that has deposited or dissociated out of feedstock 210 or 310.

The reforming feedstock 234 and the plasma initiated by the glide-arc plasma 232 in turn flow into the reaction zone 240. The reaction zone 240 is coupled with a microwave emitter 250 that directs a microwave 252 toward the reaction zone 240, thereby further energizing a hybrid plasma 242 in the reaction zone 240 acting upon the reforming feedstock 234. Tuning of the microwave emitter 250 provides control over the plasma 242 in order to maintain preferred reaction conditions in the zone 240 to further dissociate hydrocarbons of the reforming feedstock 234 to hydrogen and carbon and lighter hydrocarbons.

The reforming feedstock 234 and the plasma 242 further flows into a reaction zone 260. The reaction zone 260 is likewise coupled with a microwave emitter 270 that directs a microwave 272 toward a reaction zone 260, thereby further energizing a hybrid plasma 262 in a reaction zone 260 acting upon the reforming feedstock 234. Tuning of the microwave emitter 270 likewise provides control over the plasma 262 in order to maintain preferred reaction conditions in the zone 260 to further dissociate hydrocarbons of the reforming feedstock 234 to hydrogen, carbon and lower hydrocarbons (relative to hydrocarbons the hydrocarbons entering the reaction zone 260).

An important consideration for this embodiment is to reform as much of the hydrocarbon from the feedstock to hydrogen by excitation of energy levels beyond the dissociation level for the hydrocarbon. To achieve this, a series of microwave emitters other than the microwave emitters 250 and 270 can be directed toward the reforming feedstock 234 in reaction zones other than the reaction zones 240 and 260 as well as in reaction zones 240 and 260. Microwave emitters, waveguides, or microwave generators can be combined or added to one or more reaction zones of system 200 to increase or otherwise tune reformation of feedstock to carbon, hydrogen, and lighter hydrocarbons. The length of the zones or number of reaction zones and microwave emitters in the series can be selected based on the types of hydrocarbons in the feedstock, the quality or purity of the feedstock, or the performance/efficiency of upstream components throughout operation of the system. It is further contemplated that inductive coils be configured between microwave reaction zones to inductively coupled with and energize the hybrid plasma, thus propagating the reaction zone while receiving inductive feedback from the plasma. In this embodiment, the extended reaction zone from igniting the reactive plasma 232 throughout the depicted reaction zones is the reaction zone 201.

To that end, the reforming feedstock 234 and interacting plasmas can further flow from the reaction zone 260 through a number of similar reaction zones energized by microwaves, ultimately leading to the reaction zone 280. The reaction zone 280 is likewise coupled with a microwave emitter 290 that directs a microwave 292 toward a reaction zone 280, thereby further energizing a hybrid plasma 282 in the reaction zone 280 acting upon the reforming feedstock 234. Tuning of the microwave emitter 290 likewise provides control over the plasma 282 in order to maintain preferred reaction conditions in the zone 280 to further dissociate hydrocarbons of the reforming feedstock 234 to hydrogen and carbon. The reformed feedstock 284 is then output from system 200, and includes a low concentration of feedstock hydrocarbons relative to a high concentration of hydrogen. To the extent hydrogen, or carbon, was removed from the system 200 throughout the reaction zone 201, the reformed feedstock 284 may contain primarily unreformed hydrocarbons or intermittent lighter hydrocarbons recycled back into the feedstock 210.

A filtering structure can further be disposed between reaction zones or after the last reaction zone to interact with the reacted species, and can be for example one of a porous substrate, a permeable layer, a semi-permeable layer, a selectively permeable layer, or a gradient, or combinations thereof. Likewise a directing structure can be disposed to interact with the reacted species, for example a rotor, a capillary, or a cavity, or combinations thereof.

FIG. 3 depicts a diagram of a system 300 of the inventive subject matter, which is similar in some aspects to the system 200 described above with respect to FIG. 2. A noted difference here is the progression of a feedstock 310 from a plasma 322 directly to a plasma 342, which is energized by microwave 352. The feedstock 310 containing hydrocarbons is fed into a pre-treatment zone 320, which includes a plasma 322. The plasma 322 is preferably a DBD plasma tuned to maintain a plasma temperature of less than 500° C., 600° C., 700° C., 800° C., 400° C., 300° C., 200° C., or less than 100° C. in the pre-treatment zone 320 and to increase the excitation levels of the hydrocarbons in the feedstock, maintaining such levels below a dissociation level of the hydrocarbons, for example 90% of dissociation level.

Excitation of the hydrocarbon feedstock by the plasma 322 forms an excited feedstock 324, which is fed into a reaction zone 330, which is configured to generate a plasma 332. The reaction zone 330 is coupled with a microwave emitter 340 that directs a microwave 342 toward the reaction zone 330, thereby increasing the energy of the excited feedstock 324 beyond the dissociation level of the hydrocarbons and reforming the hydrocarbons into their constituent components. Tuning of the microwave emitter 340 provides control over the plasma 332 in order to maintain preferred reaction conditions in the zone 330 to dissociate hydrocarbons of the excited feedstock 324 to hydrogen, carbon, and lighter hydrocarbons. As describe herein, the feedstock 310 or 324 that has been partly been reformed into the components may be referred to herein as a reforming feedstock 334. In some embodiments, a microwave emitter 340 is tuned such that a microwave 342 maintains a plasma in a reaction zone 332 that does not excite the excited feedstock above the dissociation level of the hydrocarbons. In such embodiments, the reaction zone 330 can be viewed as a holding area of excited feedstock for batch processing.

The reforming feedstock 334 is fed into a zone 350 having a glide-arc plasma 352. The plasma 352 is used to further energize hydrocarbons in the reforming feedstock 334 to an energy level higher than the dissociation level for the hydrocarbons. The reforming feedstock 334 is then fed into subsequent reaction zones 360 and 380, each of which is coupled to the microwave emitters 370 and 390 for directing microwaves 372 and 392 at the respective reaction zone, as depicted and described above. The expansion of the system 300 for continued dissociation of hydrocarbon feedstock to hydrogen, carbon, and lighter hydrocarbons is depicted as reaction zone 301.

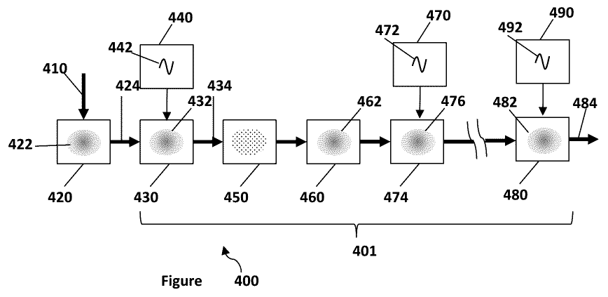

FIG. 4 depicts a diagram of a system 400 of the inventive subject matter, which is similar in some aspects to the system 300 described above with respect to FIG. 3. A noted difference here is, after the progression of a feedstock 410 from a plasma 422 directly to a plasma 432, which is energized by a microwave 442, a reforming feedstock 434 passes through a filter 450. The feedstock 410 containing hydrocarbons is fed into a pre-treatment zone 420, which is configured to generate a plasma 422, e.g., a DBD plasma. The plasma 422 is tuned to maintain a plasma temperature of less than 500° C., 600° C., 700° C., 800° C., 400° C., 300° C., 200° C., or less than 100° C. in a pre-treatment zone 420 and to increase the excitation levels of the hydrocarbons in the feedstock, maintaining such levels below a dissociation level of the hydrocarbons as noted.

Excitation of the hydrocarbon feedstock by the plasma 422 forms an excited feedstock 424, which is fed into a reaction zone 430 configured to generate a plasma 432. The reaction zone 430 is coupled with a microwave emitter 440 that directs a microwave 442 toward a reaction zone 430, forming and maintaining the plasma 432. The plasma 432 increases the energy of the excited feedstock 424 beyond the dissociation level of the hydrocarbons and reforms the hydrocarbons into their constituent components. Tuning of the microwave emitter 440 provides control over the plasma 432 in order to maintain preferred reaction conditions in the zone 430 to dissociate hydrocarbons of the excited feedstock 424 to hydrogen, carbon, and lighter hydrocarbons. As describe herein, the feedstock 410 or 424 that has partly been reformed into the components may be referred to herein as a reforming feedstock 434.

As the plasma 432 dissociates hydrocarbons into hydrogen and lighter hydrocarbons, carbon accumulates and can coat the surfaces of the reaction zone 430 and downstream components, such as electrodes resident in the reaction zone 460 related to glide-arc plasma formation. To prevent such carbon accumulation from damaging or reducing the efficiency of downstream components, the reforming feedstock 434 passes through the filter 450. While the filter 450 typically removes accumulated carbon, in some embodiments it further acts to bleed off hydrogen produced thus far in the system 400.

Carbon generated by the inventive subject matter includes carbon particles, carbon colloids, carbon nanostructures (e.g., nanofibers, nanoparticles, nanotubes, composites thereof, etc.), graphite, graphene, fullerene, carbon black, soot, clumps, or other forms of solid carbon, as well as sulfur particulate, sulfur compounds, metal particulate, or metal compounds, alone or in combinations thereof. Such carbon is generally byproduct, though plasma conditions in the various zones can be tuned, altered, or controlled to generate carbon byproducts of a preferred or specific type, condition, quality, or quantity. In some embodiments, carbon generated by the inventive subject matter is the product, rather than the byproduct.

Once carbon is removed, the reforming feedstock 434 is fed into the zone 460 having a glide-arc plasma 462. The plasma 462 is used to further energize hydrocarbons in the reforming feedstock 434 past the dissociation level for hydrocarbons. The partially reformed feedstock 434 is then fed into subsequent reaction zones 474 and 480, each of which is coupled to microwave emitters 470 and 490 for directing microwaves 472 and 492 at the respective reaction zones to further energize plasmas 476 and 482 respectively, as depicted and described above. The expansion of the system for continued dissociation of hydrocarbon feedstock to hydrogen, carbon, and lighter hydrocarbons is depicted as reaction zone 401.

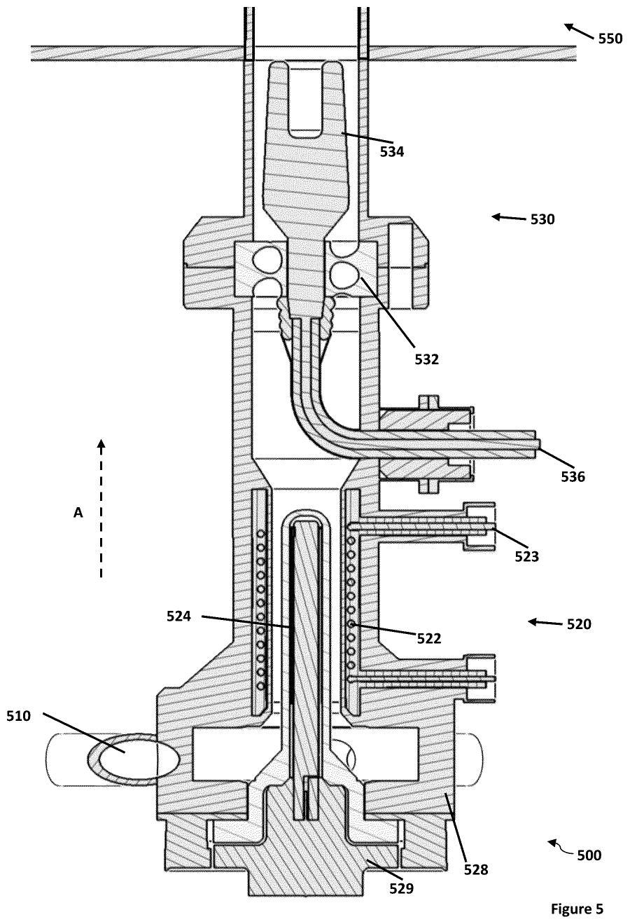

FIG. 5 depicts system 500 for reforming a hydrocarbon feedstock into hydrogen (e.g., H2) and carbon byproduct. Inlet 510 is configured to receive hydrocarbon feedstock, introducing the feedstock to system 500. As depicted, inlet 510 is upstream of induction zone 520, with feedstock flowing into induction zone 520. Induction zone 520 includes low turn coils 522 supported by an outer structure 528 and high turn coils 524 supported by inner structure 529. Preferably each or one of structures 528 and 529 are grounded. Low turn coil 522 is coupled to high voltage source 523 (source not pictured).

High-turn coil 524 is inductively coupled with and energized by low-turn coil 522. Generally High turn coil has 1.5, 2, 3, 4, 5, 10, 15, 25, 50, 100, or 1000 times as many turns of a conductor about an axis as low turn coil. System 500 includes high and low turn coils that are wrapped about a common axis and mostly (e.g., more than 50%) or substantially (e.g., more than 70%, 80%, 90% or up to 100%) overlap with each other. It is contemplated that more than one high turn coil can be wrapped about a common axis, or overlap with one or more low turn coils. In some embodiments, high-turn coil 524 forms part of a DBD electrode assembly, either directly acting as an energized electrode to produce the DBD plasma or by indirectly further energizing a separate electrode generating DBD plasma.

Feedstock flowing from inlet 510 flows in the direction of dashed arrow A through induction zone 520 past coils 524 and 522, and to zone 530. While flowing through zone 520, the hydrocarbons of the feedstock are energized to below the dissociation energy of hydrogen or carbon from the hydrocarbons or lighter (relative to the hydrocarbons) hydrocarbons. Zone 530 includes insulator 532, electrode 534, and power source 536 (power source not pictured). Insulator 532 is in the shape of a vortex, directing feedstock flowing through the system into a vortex flow pattern. Vortex flowing feedstock then flows toward electrode 534. When energized by power source 536, electrode 534 generates a glide arc plasma, preferably rotating, in zone 530.

Microwaves are directed toward and across the face of electrode 534 by microwave channel 550. The microwaves further energize the plasma from zone 530, forming a reactive plasma in channel 550. The reactive plasma in channel 550 energizes the hydrocarbons and lighter hydrocarbons of the feedstock past the dissociation energy of the hydrogen or carbon in the feedstock, and the feedstock is reformed into hydrogen, carbon, and intermittent lighter hydrocarbons.

Thus, specific systems, devices, and methods using plasma to reform hydrocarbons into hydrogen and carbon have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A plasma reformer for reforming a hydrocarbon feedstock, comprising:
a tube having an inlet configured to receive the feedstock, and an outlet configured to discharge reformation products formed by reforming the feedstock through first to third reaction zones within the tube;
the first reaction zone configured to generate a first plasma using electrodes separated by an insulating barrier;
the second reaction zone at least partially downstream of the first reaction zone, the second reaction zone configured to generate a second plasma using first and second electrodes separated by a variable inter-electrode gap in a lengthwise direction of the tube and configured to deliver an electric discharge to produce a second plasma different from the first plasma; and
the third reaction zone at least partially downstream of the first reaction zone, the third reaction zone configured to direct a first energy in a direction crossing the lengthwise direction through the feedstock to produce a third plasma different from the first and second plasmas.

2. The plasma reformer of claim 1, wherein the first reaction zone is configured to generate the first plasma without substantially dissociating hydrocarbons in the feedstock.

3. The plasma reformer of claim 2, wherein one or both of the second and third reaction zones are configured to substantially dissociate the hydrocarbons in the feedstock.

4. The plasma reformer of claim 1, wherein the first plasma is a dielectric barrier discharge plasma that induces a plasma temperature in the feedstock of between 20° C. and 1200° C.

5. The plasma reformer of claim 1, wherein the first plasma is one of a dielectric barrier discharge plasma, a corona plasma, a pulsed plasma, a nano-pulsed plasma, or an electron-beam induced plasma, and has a plasma frequency between 50 Hz and 40 kHz.

6. The plasma reformer of claim 1, further comprising a voltage across the first and second electrodes between 1 kV and 60 kV.

7. The plasma reformer of claim 1, wherein the third reaction zone is downstream of the second reaction zone.

8. The plasma reformer of claim 1, wherein the second reaction zone is downstream of the third reaction zone.

9. The plasma reformer of claim 1, wherein the second reaction zone overlaps with the third reaction zone in the lengthwise direction.

10. The plasma reformer of claim 1, wherein the second plasma is a glide-arc plasma and has a plasma frequency between 300 MHz and 4 GHz.

11. The plasma reformer of claim 1, wherein the third plasma has a frequency that oscillates with a harmonic of the second plasma.

12. The plasma reformer of claim 1, wherein the first plasma (i) initiates vibrational excitation in a compound in the feedstock, (ii) energizes electrons of the compound in the feedstock, or (iii) energizes the compound in the feedstock with an energy having a magnitude between 50% and 95% of a dissociation energy of the compound.

12. The plasma reformer of claim 1, wherein the third plasma has a plasma frequency within 3% of a plasma frequency of the second plasma.

14. The plasma reformer of claim 1, wherein the first plasma includes a dielectric barrier discharge plasma, the second plasma includes a glide-arc plasma, and the third plasma includes a microwave plasma.

15. The plasma reformer of claim 1, wherein the first reaction zone is configured for a dielectric barrier discharge plasma, the second reaction zone is configured for a microwave plasma, and the third reaction zone is configured for a glide-arc plasma.

16. The plasma reformer of claim 1, further comprising a carbon filter between the second and third reaction zones.

17. The plasma reformer of claim 1, wherein the first energy is a first microwave energy, and further comprising a first microwave emitter configured to direct the first microwave energy into the third reaction zone via a first waveguide, the first waveguide overlaps at least 5 cm of a length of the tube.

18. The plasma reformer of claim 17, further comprising a fourth reaction zone at least partially downstream of the third reaction zone, the fourth reaction zone configured to direct a second microwave energy into the third plasma to produce a fourth plasma.

19. The plasma reformer of claim 18, wherein the fourth plasma includes a microwave plasma with a frequency that oscillates with a harmonic of the third plasma frequency.

20. The plasma reformer of claim 18, further comprising a carbon filter downstream of either the third reaction zone or the fourth reaction zone.

21. The plasma reformer of claim 20, further comprising a second microwave emitter configured to direct a second microwave energy into the third reaction zone via a second waveguide, the second waveguide overlaps at least 5 cm of a length of the tube.

22. The plasma reformer of claim 18, wherein the third and fourth reaction zones have no active electrodes in direct contact with the fourth plasma.

23. The plasma reformer of claim 18, further comprising an inductively coupled plasma reaction zone downstream of the fourth reaction zone, the inductively coupled plasma reaction zone configured to direct energy from operation of a high-turn and a low-turn coil disposed about the inductively coupled plasma reaction zone into the fourth plasma to produce an inductively coupled plasma downstream of the fourth reaction zone.

24. The plasma reformer of claim 1, further comprising an inductively coupled plasma reaction zone downstream of the third reaction zone, the inductively coupled plasma reaction zone configured to direct energy from operation of a high-turn and a low-turn coil disposed about the inductively coupled plasma reaction zone into the third plasma to produce an inductively coupled plasma downstream of the third reaction zone.

25. The plasma reformer of claim 24, wherein the inductively coupled reaction zone has no electrode in direct contact with the inductively coupled plasma and the feedstock.
